(19) United States
(12) Patent Application Publication
(10) Pub. No.: US 2012/0132190 A1
(43) Pub. Date: May 31, 2012

(54) METHOD OF SMOKE-FREE GRILLING

(76) Inventor: WILLIAM HOME, TAIPEI (TW)

(21) Appl. No.: 12/954,621

(22) Filed: Nov. 25, 2010

(51) Int. Cl. A47J 37/07

(52) U.S. Cl. 126/25 R

(57) ABSTRACT

A smoke-free grilling method includes (1) arranging a heating unit inside a grill in such a way that the heating unit is not shielded by any shade located above; (2) combining a grilling grid with a shielding section and arranging the grid on a top opening of the grill; and (3) setting the shielding section to correspond in position to the heating unit arranged inside the grill, whereby when the grid receives foodstuff positioned thereon for grilling, the shield section provides a function of shielding so that liquid substances, such as grease and juice of the grilled foodstuffs and sauce applied to the foodstuffs, are prevented from dropping onto the heating unit to cause flaming or smoke, and true smoke-free grilling is achieved and functions of health, environmental protection, and energy conservation are also achieved.

### (a) TECHNICAL FIELD OF THE INVENTION

The present invention generally relates to a method of smoke-free grilling, and more particularly to a smoke-free grilling method that is effective for grilling in a truly smoke-free fashion by combining a grilling grid with a shielding section in such a way that the shielding section is positioned corresponding to a heating unit set up inside the grill kettle so that during the process of grilling foodstuffs, liquid substances, such as grease and juice of the grilled foodstuffs and sauce applied to the foodstuffs, are prevented from dropping onto the heating unit to generate flaming or smoke.

### (b) DESCRIPTION OF THE PRIOR ART

Grilling or barbecue is a common activity for modern people, for it allows people to taste foodstuffs that are processed in different ways and it also serves as an easy measure for social communication.

To make barbeque, a grill is prepared. In the conventional way of grilling with a known grill, a cooking grid or grilling grid is positioned on a top opening of the grill. Charcoals or other suitable fuels are deposited in the grill for burning, or alternatively, a burner (such as an infrared heater) is provided. With such an arrangement, foodstuffs may be placed on the grill to be heated by the charcoal fire or the burner for cooking. However, the charcoals or burners used in the conventional grills are arranged to give off thermal radiation directly toward the grid for heating the foodstuffs placed thereon, whereby the charcoal fire or the burner directly opposes openings of the grid positioned above the charcoal fire or burner. This allows liquid substances, such as sauces and greases and juices of foodstuffs, to directly fall onto the charcoal fire or the burner, whereby a large amount of thick smoke may be generated, which may cause air pollution and contamination of the foodstuffs, and is also harmful to human bodies.

As shown in FIG. 7, a conventional way of grilling using a known grill 90 that comprises a burner as a heat source is shown. The grill 90 has a top opening on which a cooking grid 91 is position and a protection shade 93 (such as a carbon screen) is arranged above a burner unit 92 (such as a burner) located inside the grill. With a shielding function provided by the protection shade 93, in grilling foodstuffs, liquid substances, such as grease and juice of the grilled foodstuff and sauce applied to the foods, are only allowed to drop onto the protection shade 93 and are prevented from dropping on the burner unit 92 to cause flaming or acid/alkali corrosion. The conventional grill 90 has several structural drawbacks, which will be briefly described as follows:

(1) Due to the arrangement of the protection shade 93, the thermal energy emitting from the burner unit 92 cannot be directly applied to the cooking grid 91, leading to additional consumption of thermal energy and an increase of the manufacturing cost of the grill.

(2) Although a protection shade 93 is provided to shield and thus prevent liquid substances, such as grease and juice of grilled foodstuffs and sauce applied to the foods, to directly dropping on the burner unit 92, yet the protection shade 93 itself is heated by the thermal radiation from the burner unit 92 and thus similar result of flaming and smoking may occur when the liquid substances, such as grease and juice of the grilled foodstuffs and sauce applied to the foods, fall onto the protection shade 93.

Apparently, the conventional ways of cooking foodstuffs with grills are not truly smoke free. It is thus desired to provide a grilling utensil that combines a grilling grid and a burner shade together to apply to food grilling with a grill so as to actually achieve smoke-free grilling, as well as simplification of the structure of grilling utensils.

### SUMMARY OF THE INVENTION

An objective of the present invention is to provide a method of smoke-free grilling, wherein there is no need to install a protection shade inside a grill for protecting a burner of the grill, and realizing true smoke-free grilling.

To achieve the above objective, the present invention provides a smoke-free grilling method comprising the following steps: (1) arranging a heating unit inside a grill in such a way that the heating unit is not shielded by any shade located above; (2) combining a grilling grid with a shielding section and arranging the grid on a top opening of the grill; and (3) setting the shielding section to correspond in position to the heating unit arranged inside the grill, whereby when the grid receives foodstuff positioned thereon for grilling, the shield section provides a function of shielding so that liquid substances, such as grease and juice of the grilled foodstuffs and sauce applied to the foodstuffs, are prevented from dropping onto the heating unit to cause flaming or smoke, and true smoke-free grilling is achieved and functions of health, environmental protection, and energy conservation are also achieved. Further the thermal energy emitting from the heating unit is allowed to directly apply to the grid to provide an advantage of energy saving.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional schematically demonstrating a smoke-free grilling method according to the present invention.

FIG. 2 is a perspective view showing a grilling grid used in the method according to the present invention.

FIG. 3 is a perspective view showing the structure of an opposite side of the grid used in the method of the present invention.

FIG. 4 is a cross-sectional view showing the grid used in the method of the present invention that is used in an up-side down fashion.

FIG. 5 is a perspective view showing a gird having a different structure to be used in the method of the present invention.

FIG. 6 is a cross-sectional showing the grid of said different structure used in the method of the present invention positioned on a grill.

FIG. 7 is a cross-sectional showing a conventional way of cooking food with a grill.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

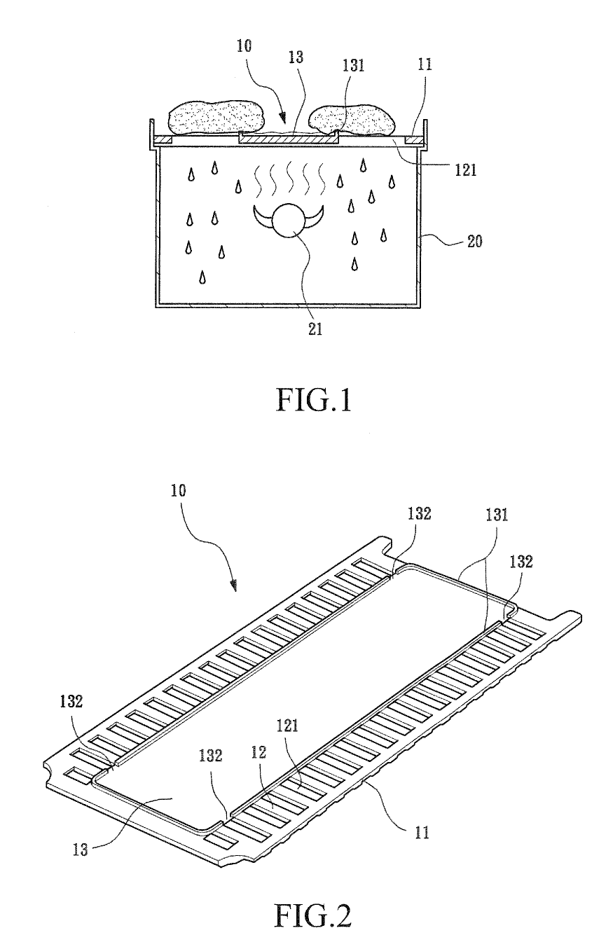

Referring to FIGS. 1 and 2, the present invention provides a method of smoke-free grilling, which achieves true smoke-free grilling in cooking foods with a grill. The method comprises the following steps:

(1) arranging a heating unit 21 inside a grill 20, wherein the heating unit 21 can be an infrared heater, a burner, and an electrical heating tube, and the heating unit 21 is not shielded by any shade located above;

(2) combining a grilling grid 10 that comprises a frame 11, a plurality of bars 20, and a plurality of openings 121 with a shielding section 13 and arranging the grid 10 on a top opening of the grill 20; and

(3) setting the shielding section 13 to correspond in position to the heating unit 21 arranged inside the grill 20.

With such a method, when the cooking grid 10 is positioned on the top opening of the grill 20 and supports foodstuff thereon for grilling, the shield section 13 provides a function of shielding so that liquid substances, such as grease and juice of the grilled foodstuffs and sauce applied to the foodstuffs, are drained through the openings 121 and fall vertically so that they do not drop onto the heating unit 21 to cause undesired flaming or smoke, and true smoke-free grilling is achieved. Since no object (such as a protection shade) is arranged between the heating unit 21 and the grid 10, the heating unit 21 may emit thermal energy that is directly applied to the grid 10 to thereby provide functions of health, environmental protection, and energy conservation.

Referring to FIGS. 1 and 2, in the smoke-free grilling method of the present invention, a grilling grid 10 is used, which has the following features:

The frame 11 is positionable on the top opening of the grill 20;

The bars 12 and the shield section 13 are arranged inside the frame 11 for carrying and supporting foodstuffs positioned thereon. The shield section 13 is arranged at a location corresponding to a heating unit 21 that is arranged inside the grill 20. In the instant embodiment, the heating unit 21 of the grill 20 is arranged at a central portion, so that the shield section 13 is also set at the central portion of the grid 10. The shield section 13 has a circumference on which a plurality of raised rims 131 is formed, so that the raised rims 131 of the shield section 13 delimit and define a recessed flat-bottom chamber therebetween for receiving and containing liquid substances, such as grease and juice of foodstuffs and sauce applied to the foodstuffs, and the liquids are constrained from randomly spreading. The raised rims 131 form therebetween a plurality of notches 132 at predetermined locations through which the liquid substances of grease and juice of foodstuffs and sauce may flow off. The bars 12 are distributed on opposite sides of the shield section 13 and the openings 121 are formed between adjacent ones of the bars 12 to allow thermal radiation emitting from the heating unit 21 to travel through the openings 121 and also to allow the liquids draining off the notches 132 to drop down through the openings 121.

As shown, the raised rims 131 form a recessed chamber therebetween, which can function as a grilling pan or may collect liquid substances, such as grease and juice of the grilled foodstuffs and sauces applied to the foodstuffs, therein. Even under a condition that the grill 20 is not set on a flat surface, the raised rims 131 are also effective in preventing random flow of liquid substances, such as grease and juice of the grilled foodstuffs and sauce applied to the foodstuffs, and guiding and conducting the liquid substances to flow out of the shield section through the notches 132 to subsequently drop down through the openings 121 between the bars 12.

Further, when the heating unit 21 is set up in for example a longitudinal direction, the bars 12 and the openings 121 of the grid 10 are oriented in a lateral direction with respect to the heating unit 21. This helps guiding thermal radiation from the heating unit 21 to transmit through the openings 121.

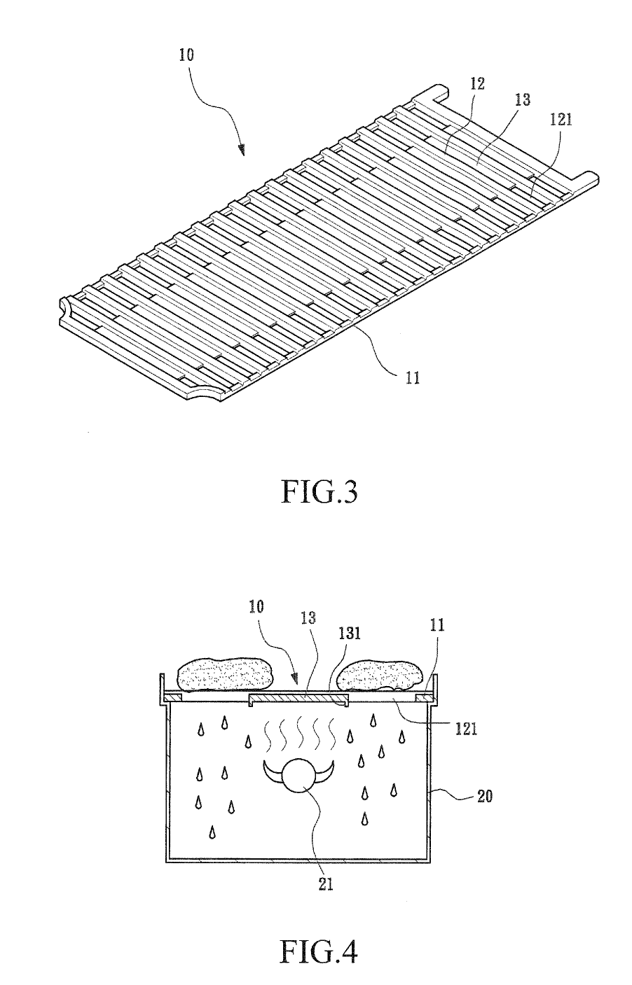

Further referring to FIGS. 3 and 4, a different way of use of the grid that is used in the smoke-free grilling method according to the present invention is illustrated, where the grid is turned up-side down (namely, the shield section 13 being reversed to have the raised rims 131 located on the underside) so that the grid may serve as a different grid that forms flow guide structure on the reversed shield section 13 by having the bars 12 extending on and across the shield section so that portions of the bars 12 get raised above the shield section 13. The spaced raised portions of the bars 12 forms grooves therebetween to serve as a flow guide structure and also to prevent the foodstuff positioned thereon from directly contacting shield section 13.

Use in this way still allows the shield section 13 to provide a shielding function and also provides a flow guiding function with the grooves defined between the raised portions of the bars 12 on the shield section 13, whereby liquid substances, such as grease and juice of the grilled foodstuffs and sauce applied to the foodstuffs, are constrained to drain off only through the openings 121 between the bars 12 and not dropping on the heating unit 21 to cause flaming or smoke. Further, since no protection shade is arranged between the heating unit 21 and the grid 10, the heating unit 21 may emit thermal energy that is directly applied to the grid 10 to thereby provide functions of health, environmental protection, and energy conservation.

As shown, the raised rims 131 that face downward in this case may be helpful in conducting liquid substances, such as grease and juice of the grilled foodstuffs and sauce applied to the foodstuffs, to drop downward without flowing in a transverse direction due to being positioned on an uneven surface.

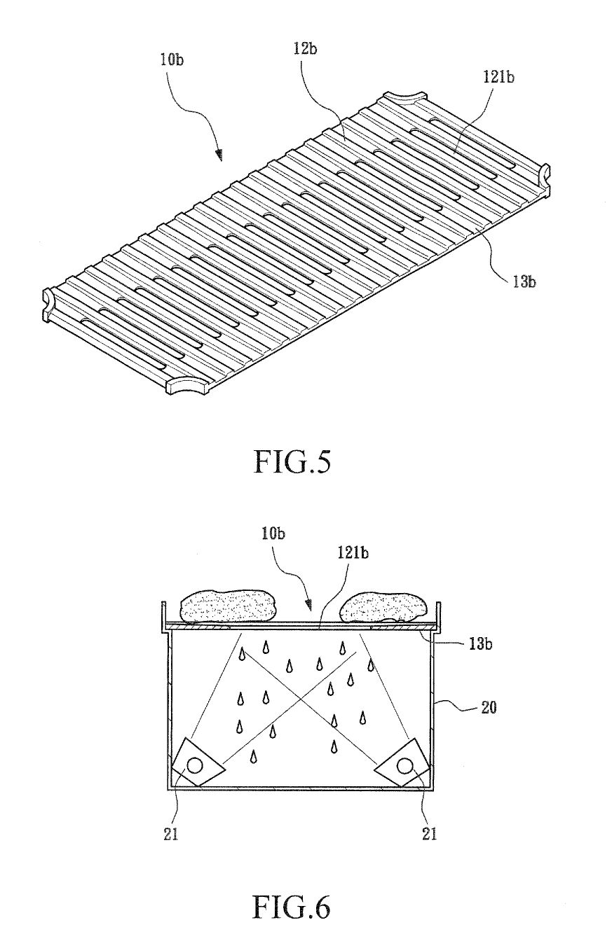

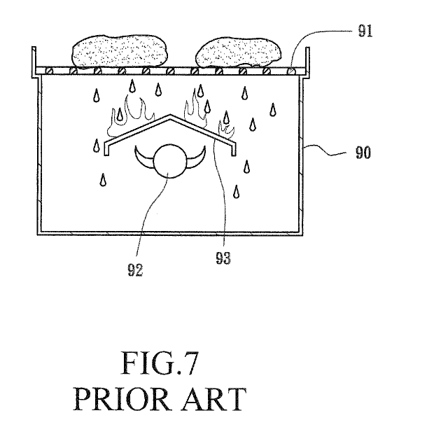

Referring to FIGS. 5 and 6, a grilling grid having a different structure for used in the smoke-free grilling method according to the present invention is shown, which is applicable to the situation where heating units 21 are arranged on opposite sides of a grill 20. In such a situation, shield sections 13b are arranged to correspond in position to the heating units 21 and are thus located on two opposite side portions of the grid 10b with a central portion of the grid 10b being hollow and bars 12b extending across the hollow portion and defining openings 121b therebetween.

With such an arrangement of the grilling grid 10b, the same function of shielding can be achieved with the shield sections 13b, and also, portions of the bars 12b that extend on the shield section 13b form grooves therebetween to provide a function of flow guiding, which allows liquid substances, such as grease and juice of the grilled foodstuffs and sauce applied to the foodstuffs, to drain off only through the openings 121b between the bars 12b and not dropping on the heating units 21 to cause flaming or smoke. Since no protection shade is arranged between the heating units 21 and the grid 10b, the heating units 21 may emit thermal energy that is directly applied to the grid 10b to thereby provide functions of health, environmental protection, and energy conservation.

In summary, according to the present invention, a grilling grid is integrated with a shielding section with the shielding section being positioned corresponding to a heating unit arranged inside a grill, in cooking foodstuffs with a grill, liquid substances, such as grease and juice of the grilled foodstuffs and sauce applied to the foodstuffs, do not drop onto the heating unit to cause flaming and smoke so as to achieve true smoke-free grilling operation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A smoke-free grilling method, comprising the following steps:
(1) arranging a heating unit inside a grill in such a way that the heating unit is not shielded by any shade located above;
(2) combining a grilling grid with a shielding section and arranging the grid on a top opening of the grill; and
(3) setting the shielding section to correspond in position to the heating unit arranged inside the grill;
whereby when the grid receives foodstuff positioned thereon for grilling, the shield section provides a function of shielding so that liquid substances, such as grease and juice of the grilled foodstuffs and sauce applied to the foodstuffs, are prevented from dropping onto the heating unit to cause flaming or smoke, and true smoke-free grilling is achieved and functions of health, environmental protection, and energy conservation are also achieved.

2. The method according to claim 1, wherein the shield section is arranged at a central portion of the grid.

3. The method according to claim 1, wherein the shield section is arranged at one side portion of the cooking grid.

4. The method according to claim 1, wherein the heating unit is set in a longitudinal direction and the bars and openings of the grid are set in a lateral direction with respect to the heating unit.

5. The method according to claim 1, wherein the heating unit is set in a lateral direction and the bars and openings of the grid are set in a longitudinal direction with respect to the heating unit.
